(19) United States
(12) Patent Application Publication
(10) Pub. No.: US 2024/0274920 A1
(43) Pub. Date: Aug. 15, 2024

(54) Assembly for regulating the temperature of battery cells

(71) Applicant: SOGEFI AIR & COOLING, GUYANCOURT (FR)

(72) Inventors: Nicolas BECKER, PORTE-DU-RIED (FR); Arnaud SCHUB, INGERSHEIM (FR); Mickaël DE AZEVEDO, AMMERSCHWIHR (FR); Arnaud DEMANGE, COLMAR (FR)

(21) Appl. No.: 18/569,756

(22) PCT Filed: Jun. 15, 2022
(86) PCT No.: PCT/EP2022/066330

§ 371 Date: Dec. 13, 2023

(30) Foreign Application Priority Data
Jun. 18, 2021 (FR) FR2106490

(51) Int. Cl. H01M 10/656; H01M 10/613; H01M 50/107

(52) U.S. Cl. CPC H01M 10/656; H01M 10/613; H01M 50/107

(57) ABSTRACT

An assembly has at least one battery module made up of cells oriented parallel to each other and a device for regulating the temperature of a battery module. The device has at least one substantially planar surface positioned against the respective parallel faces of the cells of the battery module and a thickness incorporating at least one circuit for distributing a heat-transfer fluid arranged opposite the respective parallel faces of at least a first group of cells. At least first respective portions of the cells of the group are opposite at least a first portion of a distribution circuit corresponding to a portion of a duct formed by a branch of a distribution circuit and at least second respective portions of the cells of the group are opposite at least a second portion of a distribution circuit corresponding to a portion of a duct formed by a branch of a distribution circuit. The average of the heat exchanges carried out respectively by each cell with the heat transfer fluids circulating in the two portions of the duct(s) of the distribution circuit is similar, or even identical, to that of the other cells of the same group.

The present invention relates to the field of devices for regulating the temperature of batteries and more particularly to the field of devices for optimized temperature regulation of cells of a battery by means of a heat-exchange fluid.

Some batteries consist of a plurality of modules, in each of which are found a plurality of cells disposed parallel to one another so that these cells are arranged to bear against the surface of a cooling plate. Cooling plates of this kind are generally produced in the form of a device that includes, on the one hand, a plane exterior surface against which the cells are intended to bear and, on the other hand, an interior volume that forms a duct arranged to form a serpentine circuit between a heat-exchange fluid feed orifice and an outlet orifice. The heat-exchange fluid injected into the cooling plate circulates along the serpentine so as to exchange heat with the various cells of the battery via the plane exterior surface against which these cells bear.

Thanks to an interior duct arranged in a circuit the convolutions whereof are distributed facing all of its plane exterior surface, the cooling plate is then in a position to provide a maximized heat-exchange surface. Nevertheless, the heat-exchange fluid circulating in cooling plates of this kind undergo a rise in temperature when it moves from the injection orifice to the outlet orifice. Also, the cells positioned along the route, facing the beginning of the circuit, that is to say near the fluid injection orifice, exchange more heat more efficaciously than the cells positioned facing the end of the circuit, that is to say near the fluid outlet orifice when the latter is heated. Consequently, the temperature regulation effected by the heat-exchange fluid circulating in existing cooling plates is not able to take place homogeneously over all the plane exterior surface of the device. This heterogeneous regulation within the same battery module then constrains the various cells to divergent functioning efficacies that lead to premature ageing of the battery.

The present invention has for object alleviating these disadvantages by proposing a solution that enables homogeneous temperature regulation by a heat-exchange fluid for different cells of the same module of a battery, or even temperature regulation that can be specifically adjusted to a particular arrangement of the cells in the battery module.

The invention therefore has for object an assembly including at least one battery module consisting of cells oriented parallel to one another and a temperature regulation device of a battery module, the device including at least one substantially plane surface positioned against the respective parallel faces of the cells of the battery module and a thickness incorporating at least one heat-exchange fluid distribution circuit disposed facing respective parallel faces of at least one first group of cells so that:
on the one hand, at least respective first portions of the cells of the group face at least one first part of a distribution circuit corresponding to a part of a duct formed by a branch of a distribution circuit and at least respective second portions of the cells of the group face at least one second part of a distribution circuit corresponding to a part of a duct formed by a branch of a distribution circuit, and
on the other hand, the average of the exchanges of heat respectively effected by each cell with the heat-exchange fluids circulating in the two circuit parts of the distribution circuit is similar or even identical to that of the other cells of the same group.

The invention will be better understood thanks to the following description that relates to different preferred embodiments, provided by way of non-limiting example and explained with reference to the appended diagrammatic drawings, in which:

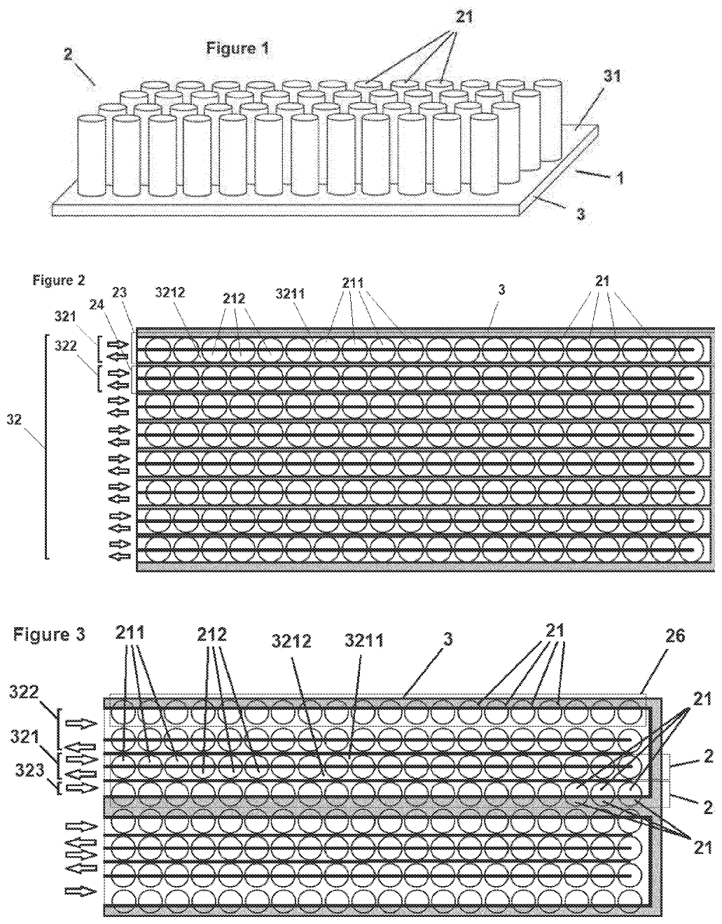

FIG. 1 is a schematic representation of one example of an assembly in accordance with the invention combining a battery module consisting of cells and a temperature regulation device,

FIG. 2 is a diagrammatic representation of one example of a first variant temperature regulation device stacked on an arrangement of cells of a battery module in an assembly in accordance with the invention as well as of the direction of movement of the various flows of heat-exchange fluid in the various branches of the distribution circuit of the device.

FIG. 3 is a diagrammatic representation of one example of a second variant temperature regulation device stacked on an arrangement of cells of a battery module in an assembly in accordance with the invention as well as of the direction of movement of the various flows of heat-exchange fluid in the various branches of the distribution circuit of the device.

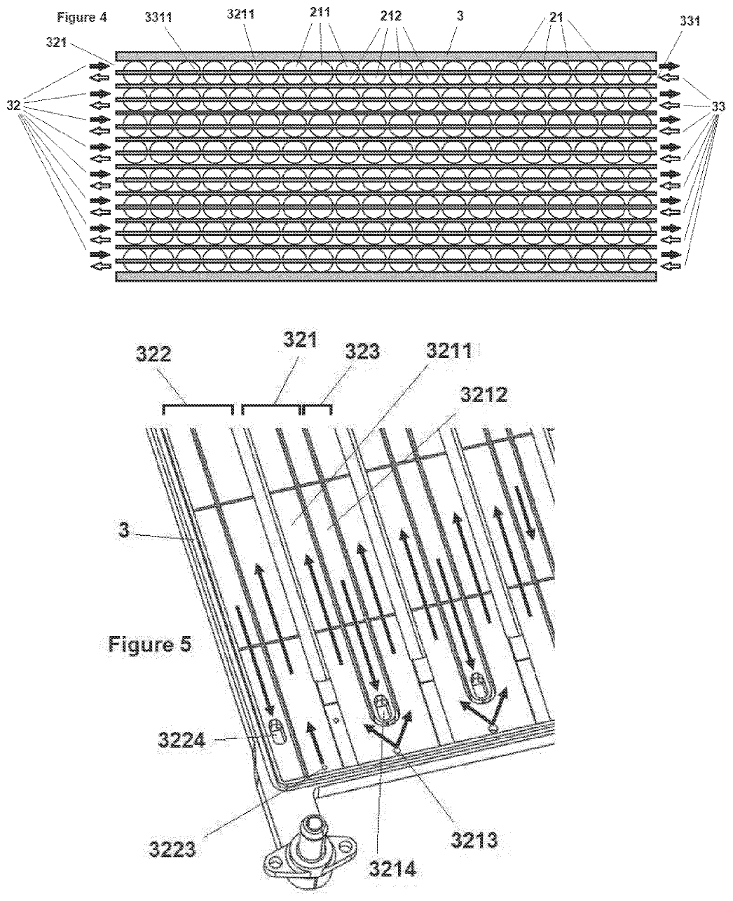

FIG. 4 is a diagrammatic representation of one example of a third variant temperature regulation device stacked on an arrangement of cells of a battery module in an assembly in accordance with the invention as well as of the direction of movement of the various flows of heat-exchange fluid in the various branches of the distribution circuit of the device,

FIG. 5 is a diagrammatic representation of details of one example of a temperature regulation device for an assembly in accordance with the invention as well as of various heat-exchange fluid flows in the distribution circuit of the device.

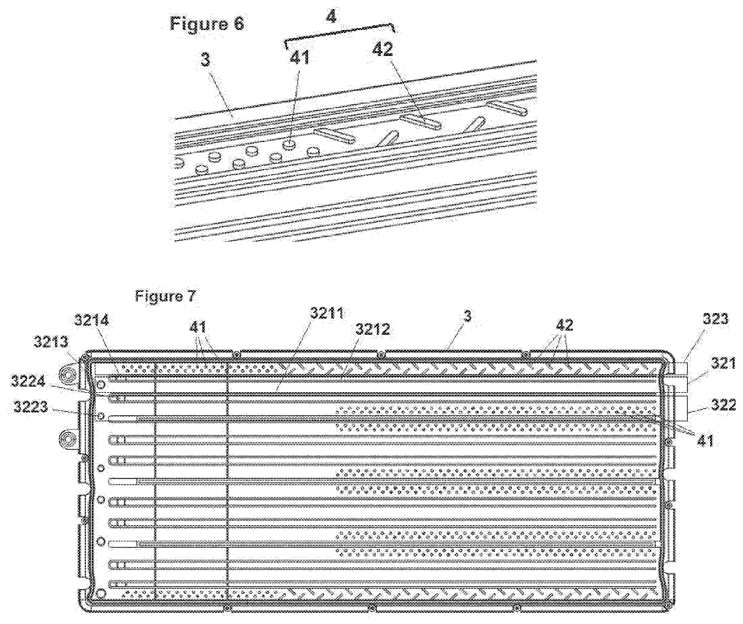

FIG. 6 is a diagrammatic representation of examples of turbulence generators for a temperature regulation device for an assembly in accordance with the invention.

FIG. 7 is a diagrammatic representation in section of one example of a temperature regulation device for an assembly in accordance with the invention.

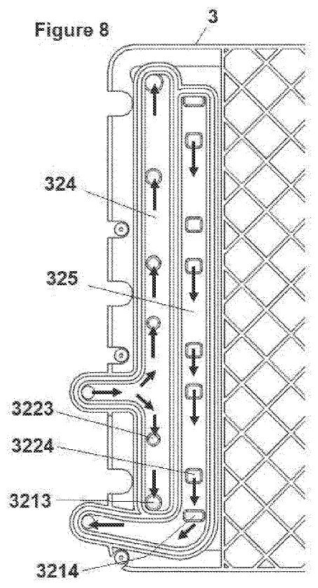

FIG. 8 is a diagrammatic representation in section of an example of manifolds in a temperature regulation device for an assembly in accordance with the invention as well as of various heat-exchange fluid flows in the distribution circuit of the device.

The invention concerns an assembly 1 including at least one battery module 2 consisting of cells 21 oriented parallel to one another and a temperature regulation device 3 of a battery module 2, the device 3 having at least one substantially plane surface 31 positioned against respective and parallel faces of the cells 21 of the battery module 2 and a thickness combining at least one heat-exchange fluid distribution circuit 32, 33 disposed facing respective parallel faces of at least one first group 23 of cells 21 so that:
on the one hand, at least respective first portions 211 of the cells 21 of the group 23 face at least one first part 3211 of a distribution circuit 32 corresponding to a part of a duct formed by a branch 321 of a distribution circuit 32 and at least respective second portions 212 of the cells 21 of the group 23 face at least one second part 3212, 3311 of a distribution circuit 32, 33 corresponding to a part of a duct formed by a branch 321, 331 of a distribution circuit 32, 33, and
on the other hand, the average of the heat exchanges respectively effected by each cell 21 with the heat-exchange fluids circulating in the two parts 3211, 3212, 3311 of duct(s) of the distribution circuit 32, 33 is similar, or even identical, to that of the other cells 21 of the same group 23.

In the assembly 1 in accordance with the invention at least some of the cells 21 of a battery module 2 are arranged so that the cells 21 are positioned facing at least one distribution circuit 32, 33, straddling two parts 3211, 3212, 3311 of respective duct(s) of distribution circuit(s) 32, 33 so as to effect exchanges of heat with the heat-exchange fluids moving in each of these parts 3211, 3212, 3311 of duct(s). The assembly 1 in accordance with the invention therefore relates to an arrangement that confers on each of the cells 21 of the same first group 23 temperature regulation by respective exchanges of heat with two heat-exchange fluids at respective different temperatures and circulating in parts 3211, 3212, 3311 of respective duct(s) of distribution circuit(s) 32, 33 so that the average of the respective heat exchanges effected by each cell 21 is similar, or even identical, to that of the other cells 21 of the group 23.

In accordance with one example relating to a particular construction variant of the assembly in accordance with the invention, the two parts 3211, 3212, 3311 of duct(s) of distribution circuit(s) 32, 33 disposed facing respective and parallel faces of at least one first group 23 of cells 21 are back-to-back so as to form two parts 3211, 3212, 3311 of duct(s) back to back, so that, at the level of the same cell 21, the heat-exchange fluid at the level of a first duct part 3211 moves in the opposite direction to the heat-exchange fluid at the level of the other duct part 3212, 3311. In accordance with the arrangement of this particular embodiment, each cell 21 of the same first group 23 is positioned facing at least one distribution circuit 32, 33, straddling two parts 3211, 3212, 3311 of respective duct(s) of back to back distribution circuit(s) 32, 33. These parts 3211, 3212 are therefore arranged so as to effect a respective exchange of heat with each of the cells 21 of the same group 23 positioned facing a portion of distribution circuit(s) 32, 33. In order to obtain an average of the exchanges of heat respectively effected by each cell 21 with the circulating heat-exchange fluids that is similar, if not identical, to that of the other cells 21 of the same group 23, the flows of heat-exchange fluid at the level of two parts 3211, 3212, 3311 of duct(s) are directed in opposite directions. In the temperature regulation device 3 the heat-exchange fluids are subjected to an accumulation of heat and are subject to an increase in their temperature as they move in the distribution circuit(s) 32, 33 so that at the end of the route the heat-exchange fluids exchange less heat with the cells 21 facing which they circulate. The amplitude of the exchanges of heat with a cell 21 being proportional to the amplitude of the temperatures between that of the cell and that of the heat-exchange fluid at the point at which it passes in front of the cell 21, this amplitude of the heat exchanges is therefore degressive along the route of the heat-exchange fluid when the temperature of the latter increases because of the accumulation of heat. Also, orientation of the heat-exchange fluid flows directed in opposite directions at the level of the two parts 3211, 3212, 3311 of duct(s) enables reciprocal compensation of the degressive heat-exchange amplitudes respectively effected by the heat-exchange fluids moving in each of the parts 3211, 3212, 3311 of duct(s) of distribution circuit(s) 32, 33.

In accordance with another example relating to a particular construction variant of the assembly in accordance with the invention adapted to be combined with the embodiment described in detail above, the respective portions 211, 212 of the cells 21 of the first group 23 positioned facing respective parts 3211, 3212, 3311 of duct(s) correspond to substantially identical surfaces. In accordance with this construction variant the identical nature of surface portions 211, 212 of the cells 21 intended to effect an exchange of heat enables an identical quantity of heat to be transferred between the battery cell 21 and the heat-exchange fluids moving in each of the parts 3211, 3212, 3311 of duct(s) of distribution circuit(s) 32, 33 positioned facing that cell 21.

In accordance with another example relating to a construction variant that is an alternative to the construction variant described in detail above, the respective portions 211, 212 of the cells 21 of the first group 23 positioned facing respective parts 3211, 3212, 3311 of duct(s) correspond to substantially different surfaces. In accordance with this construction variant the difference in surface of the portions 211, 212 of the cells 21 intended to effect an exchange of heat enables preference to be given to the transfer of heat between the battery cell 21 and one of the two heat-exchange fluids moving in a first of the two parts 3211, 3212, 3311 of duct(s) of distribution circuit(s) 32, 33 positioned facing that cell 21, to the detriment of the transfer of heat with the heat-exchange fluid circulating in the second of the two parts 3211, 3212, 3311.

In accordance with another example relating to a particular construction variant of the assembly in accordance with the invention adapted to be combined with each of the construction examples described in detail above the first part 3211 of a duct formed by a branch 321 of a distribution circuit 32 and the second part 3212 of a duct formed by a branch 321 of a distribution circuit 32 disposed facing respective portions 211, 212 of each of the cells 21 of the group 23 relate to two parts 3211, 3212 of a duct formed by the same branch 321 of the same heat-exchange fluid distribution circuit 32. In accordance with this particular construction variant the branch 321 of the distribution circuit 32 includes in particular two parts 3211, 3212 positioned facing respective portions of the cells 21 of the same group 23, those two parts 3211, 3212 being joined by a loop or a curve of the circuit 32 so that the heat-exchange fluid initially flows at the level of a first part 3211 of the duct of the distribution circuit 32 positioned facing the cells 21 and then, secondly, at the level of a second part 3212 of the duct of the distribution circuit 32 also positioned facing those same cells 21. In accordance with a preferred arrangement that enables optimization of the reduced overall size of the distribution circuit 32 at the level of the junction between the two parts 3211, 3212 of the duct at the level of which the heat exchange is effected, the loop or the curve of the circuit 32 that forms this junction takes the form of a hairpin turn between the two parts 3211, 3212 of the duct.

In accordance with another example relating to a specific construction variant of the construction variant described in detail above the assembly 1 includes at least one second group 24 of cells 21 of the battery module in which respective parallel faces of the cells 21 are disposed facing at least one dedicated branch 322 of the same distribution circuit 32 as the facing branch 321 of the first group 23 of cells 21 and in accordance with an arrangement similar to that of the cells 21 of the first group 23 relative to the parts 3211, 3212 of the duct of the facing branch. In accordance with the example of this construction variant the distribution circuit 32 comprises a plurality of branches 321, 322 forming respective loops arranged in the form of serpentines or circumvolutions so that each of these branches 321, 322 of the distribution circuit 32 is arranged so as to be positioned facing a respective group 23, 24 of cells 21 of the battery module at the level of which the heat-exchange fluid circulating in a branch 321, 322 of the distribution circuit 32 is intended to effect an exchange of heat.

In accordance with another example relating to a particular construction variant of the assembly in accordance with the invention adapted to be combined with some of the construction examples described in detail above the first part 3211 of a duct formed by a branch 321 of a distribution circuit 32 and the second part 3311 of a duct formed by a branch 331 of a distribution circuit 33 disposed facing respective portions 211, 212 of each of the cells 21 of the group 23 relating to parts 3211, 3311 of ducts of two different distribution circuits 32, 33. In accordance with this example, which corresponds to a particular construction variant of the assembly according to the invention, each of the cells 21 of the same group 23 has two surface portions 211, 212 each intended for specific exchanges of heat with a dedicated branch of a respective distribution circuit 32, 33.

In accordance with another example relating to a particular construction variant of the assembly 1 in accordance with the invention and adapted to be combined with each of the various examples of construction described in detail above, the assembly 1 includes at least one additional group 25 of cells 21 of the battery module of which at least respective first portions 211 of the cells 21 of the additional group 25 face at least a part of a duct formed by a branch 323 of a distribution circuit 32 and the respective second portions 212 of the cells 21 of the additional group 25 are not positioned facing any portion of the distribution circuit 32. In accordance with this construction variant this distribution circuit 32 effects an exchange of heat with the cells 21 of the additional group 25 only at the level of their respective first portions 211 positioned facing the dedicated branch 323 of the distribution circuit 32. In accordance with a preferred arrangement of this construction variant the respective first portions 211 of the various cells 21 of the additional group 25 have larger surfaces than the second portions 212 of the cells 21 bearing against the temperature regulation device 3. This surface difference between the two portions 211, 212 of the surface of the cells 21 bearing against the temperature regulator device 3 enables the first portion 211 to be the subject of temperature regulation adapted to compensate the lack of exchange of heat liable to occur at the level of the second portion 212 of the surface of the cells 21. In accordance with another preferred arrangement of this construction variant, the ratio between the two surfaces 211, 212 exhibits a progressive variation so as to compensate the progressive increase in the temperature of the heat-exchange fluid moving in the distribution circuit 32 so that the exchanges of heat effected at the level of each of the cells 21 of the additional group 25 are similar or even identical. In accordance with one embodiment of this construction variant at least some of the cells 21 of the additional group 25 are disposed so as to bear against the surface 31 of the temperature regulation device 3 so as to be positioned at the periphery of the surface 31 of the device 3. In accordance with another example that may be combined with the previous embodiment at least some of the cells 21 of the additional group 25 are disposed bearing against the surface 31 of the temperature regulation device 3 so as to be placed in the central part of the surface 31, facing an internal structure of the device 3 which is other than a part of a distribution circuit 32, 33. In an example of a preferred arrangement of this construction variant the branch 323 of the distribution circuit 32 that effects an exchange of heat with the cells 21 of the additional group 25 forms a duct that discharges at the level of a portion of another branch 321 of the same distribution circuit 32.

In accordance with another example relating to a particular construction variant of the assembly 1 in accordance with the invention adapted to be combined with each of the various embodiments described in detail above the assembly 1 includes at least one additional group 26 of cells 21 of the battery module of which, on the one hand, at least respective first portions 211 of the cells 21 of the additional group 26 face at least a part of a duct formed by a branch 321, 322 of a distribution circuit 32 and also effects an exchange of heat with some of the cells 21 of another group 23 and, on the other hand, the respective second portions 212 of the cells 21 of the additional group 26 are not positioned facing any portion of the distribution circuit 32. The branch 321, 322 of the distribution circuit 32 that also effects an exchange of heat with the cells 21 of the additional group 26 has a construction with a surface in section suitable for a sufficient movement of fluid to ensure an exchange of heat with cells 21 of two different groups 23, 26. In accordance with this construction variant the distribution circuit 32 effects an exchange of heat with the cells 21 of the additional group 26 only at the level of their respective first portions 211 positioned facing the dedicated branch 321, 322 of the distribution circuit 32. In accordance with a preferred arrangement of this construction variant the respective first portions 211 of the various cells 21 of the additional group 26 have surfaces larger than those of the second portions 212 of the cells 21 bearing against the temperature regulation device 3. This surface area difference between the two portions 211, 212 of the surface of the cells 21 bearing against the temperature regulation device 3 enables the first portion 211 to be the subject of temperature regulation adapted to compensate the lack of exchange of heat that may arise at the level of the second portion 212 of the surface of the cells 21. In accordance with another preferred arrangement of this construction variant the ratio between the two surfaces 211, 212 has a progressive variation so as to compensate the progressive increase in the temperature of the heat-exchange fluid moving in the distribution circuit 32 so that the exchanges of heat effected at the level of each of the cells 21 of the additional group 26 are similar or even identical. In accordance with one embodiment of this construction variant at least some of the cells 21 of the additional group 26 are disposed to bear against the surface 31 of the temperature regulation device 3 so as to be positioned at the periphery of the surface 31 of the device 3. In accordance with another example that may be combined with the previous embodiment at least some of the cells 21 of the additional group 26 are disposed to bear against the surface 31 of the temperature regulation device 3 so as to be placed in the central part of the surface 31 facing an internal structure of the device 3 that is other than a part of the distribution circuit 32, 33.

In accordance with another example relating to a particular construction variant of the assembly 1 in accordance with the invention adapted to be combined with each of the various embodiments described in detail above, in part of at least one distribution circuit 32, 33 the height, the width and/or the dimensions of the duct in section at the level of this part are adjusted as a function of the required speed of movement of the heat-exchange fluid flow. Along at least one of the various branches 321, 322, 323, 331 of at least one of the distribution circuits 32, 33 the section of the duct has a variation of its dimensions as a function of the required variation of speed of the heat-exchange fluid flow in the duct. The smaller the section of a duct the higher the speed of movement of the heat-exchange fluid at the level of this section of the duct. This variation of the speed also contributes to the management of the exchanges of heat effected by the heat-exchange fluid moving at the level of each of the cells 21. Indeed, the faster the heat-exchange fluid effects a movement facing a cell 21 the greater the quantity of heat exchanged between the heat-exchange fluid and the cell 21. Also, in the context of an adjustment of the temperature regulation carried out along a part of a branch 321, 322, 323, 331 of a distribution circuit 32, 33, variations of the section of the duct that forms this branch part 321, 322, 323, 331 enables a variation of the speed of circulation of the fluid to be effected to perform a targeted adjustment of the temperature regulation by the device 3.

In accordance with another example relating to a particular construction variant of the assembly 1 in accordance with the invention adapted to be combined with each of the various construction examples described in detail above, a duct has on its internal face, at the level of at least a part of it, at least one turbulence generator 4 produced in the form a relief. Each of these internal reliefs in the duct produces an obstacle that partly obstructs the section of the duct so that the flow of heat-exchange fluid in the duct is subjected to turbulence adapted to optimize the quality of the exchanges of heat between the heat-exchange fluid in motion and the cells 21 bearing against the device 3 and positioned facing the route of the distribution circuit 32, 33.

In accordance with another example relating to a specific construction variant of the construction variant described above at least one turbulence generator 4 is formed by a pin 41. The pin 41 therefore takes the form of a localized interior thickening of the wall of the duct so as to have at least one surface impacting the flow of heat-exchange fluid moving in the duct.

In accordance with another example relating to a specific construction variant of the two construction variants described in detail above at least one turbulence generator 4 is produced by a blade 42 disposed in accordance with at least one transverse component relative to the axis of the duct. The blade 42 therefore takes the form of an obstacle across the flow of heat-exchange fluid in motion in the duct. It may be noted that the shape of the section of the blade 42, plane, beveled, ogive, etc. . . . enables generation of more or less turbulence at the level of the flow of heat-exchange fluid.

In accordance with another example relating to a particular construction variant of the assembly 1 in accordance with the invention adapted to be combined with each of the various construction examples described in detail above at least one distribution circuit 32 includes at least one inlet manifold 324 formed by a duct producing a junction between the various inlet orifices 3213, 3223 of the respective branches 321, 322, 323 of the distribution circuit 32 and at least one outlet manifold 325 formed by a duct producing a junction between the various outlet orifices 3214, 3224 of the respective branches 321, 322, 323 of the distribution circuit 32. This construction variant that incorporates an inlet manifold 324 and an outlet manifold 325 in a distribution circuit 32 is able to distribute the heat-exchange fluid between the various branches 321, 322, 323 of the distribution circuit 32 in a controlled manner. Indeed, the distribution of the heat-exchange fluid between the various branches 321, 322, 323 can be adjusted by appropriate dimensions in section of the duct of at least one of the manifolds 324, 325, preferably the inlet manifold 324. These dimensions in section of the duct are liable to affect the height, the width and also even the shape of the duct of the manifold 324, 325.

In accordance with another example relating to a specific construction variant of the construction variant described in detail above the orifices 3213, 3223 distributed by the inlet manifold 324 have respective heights, widths and/or dimensions adjusted as a function of the required heat-exchange fluid flow at the level of the respective branches 321, 322, 323 of the distribution circuit 32. These particular dimensions enable predefined management of the distribution of the heat-exchange fluid between the various branches 321, 322, 323 of the distribution circuit 32 so that the heat-exchange fluid flow is efficaciously distributed between the various branches 321, 322, 323 in order to obtain temperature regulation at the level of each of the distributed branches 321, 322, 323. Also, the orifices 3213, 3223 distributed by the inlet manifold 324 preferably have greater sections at a distance from the point at which the inlet manifold 324 is fed.

Of course, the invention is not limited to the embodiments described and/or represented in the appended drawings. Modifications remain possible, in particular from the point of view of the constitution of the various elements or by substitution of technical equivalents, without departing from the scope of protection of the invention.

1. An assembly including at least one battery module including cells oriented parallel to one another and a temperature regulation device of a battery module, the device including at least one substantially plane surface positioned against the respective parallel faces of the cells of the battery module and a thickness incorporating at least one heat-exchange fluid distribution circuit disposed facing respective parallel faces of at least one first group of cells so that:
on the one hand, at least respective first portions of the cells of the group face at least one first part of a distribution circuit corresponding to a part of a duct formed by a branch of a distribution circuit and at least respective second portions of the cells of the group face at least one second part of a distribution circuit corresponding to a part of a duct formed by a branch of a distribution circuit, and
on the other hand, the average of the exchanges of heat respectively effected by each cell with the heat-exchange fluids circulating in the two parts of duct(s) of the distribution circuit is either similar or identical to that of the other cells of the same group.

2. The assembly as claimed in claim 1, wherein the respective portions of the cells of the first group positioned facing respective parts of duct(s) of the distribution circuit are substantially identical surfaces.

3. The assembly as claimed in claim 1, wherein the respective portions of the cells of the first group positioned facing respective parts of duct(s) of the distribution circuit correspond to substantially different surfaces.

4. The assembly as claimed in claim 1, wherein the two parts of duct(s) of distribution circuit(s) disposed facing respective parallel faces of at least one first group of cells are back-to-back with one another so as to produce two parts of back-to-back duct(s) so that at the level of the same cell the heat-exchange fluid at the level of a first duct part moves in the opposite direction to the heat-exchange fluid in the other duct part.

5. (canceled)

6. The assembly as claimed in claim 4, wherein the assembly includes at least one second group of cells of the battery module in which the respective parallel faces of the cells are disposed facing at least one dedicated branch of the same distribution circuit as the facing branch of the first group of cells and an arrangement similar to that of the cells of the first group relative to the parts of the duct of the facing branch.

7. The assembly as claimed in claim 1, wherein the first part of a duct formed by a branch of a distribution circuit and the second part of a duct formed by a branch disposed facing respective portions of each of the cells of the group relate to parts of ducts of two different distribution circuits.

8. The assembly as claimed in claim 1, wherein the assembly includes at least one additional group of cells of the battery module in which at least respective first portions of the cells of the additional group face at least a part of a duct formed by a branch of a distribution circuit and the respective second portions of the cells of the additional group are not positioned facing any portion of the distribution circuit.

9. The assembly as claimed in claim 1, wherein the assembly includes at least one additional group of cells of the battery module in which, on the one hand, at least respective of the cells of the additional group face at least a part of a duct formed by a branch, of a distribution circuit that also effects an exchange of heat with some of the cells of another group and, on the other hand, the respective second portions of the cells of the additional group are not positioned facing any portion of the distribution circuit.

10. The assembly as claimed in claim 1, wherein, in a part of at least one distribution circuit, the height, the width and/or the dimensions in section of the duct at the level of that part are adjusted as a function of the required speed of movement of the flow of heat-exchange fluid.

11. The assembly as claimed in claim 1, wherein a duct includes on at least a part of its internal face at least one turbulence generator produced in the form of a relief.

12. The assembly as claimed in claim 11, wherein at least one turbulence generator is formed by a pin.

13. The assembly as claimed in claim 11, wherein at least one turbulence generator takes the form of a blade disposed with at least one transverse component relative to the axis of the duct.

14. The assembly as claimed in claim 1, wherein at least one distribution circuit includes at least one inlet manifold formed by a duct making a junction between the various inlet orifices of the respective branches of the distribution circuit and at least one outlet manifold formed by a duct forming a junction between the various outlet orifices of the respective branches of the distribution circuit.

15. The assembly as claimed in claim 12, wherein the orifices distributed by the inlet manifold have respective heights, widths and/or dimensions adjusted as a function of the required heat-exchange fluid flow at the level of the respective branches of the distribution circuit.
